(19) United States
(12) Patent Application Publication
(10) Pub. No.: US 2025/0085106 A1
(43) Pub. Date: Mar. 13, 2025

(54) MARKING DEVICE TRACKING

(71) Applicant: Hewlett-Packard Development Company, L.P., Spring, TX (US)

(72) Inventors: Xavier OLIVA VENTAYOL, Sant Cugat del Valles (ES); Lluis ABELLO ROSELLO, Sant Cugat del Valles (ES); Borja NAVAS SANCHEZ, Sant Cugat del Valles (ES); Ramon VIEDMA PONCE, Sant Cugat de Valles (ES); Marina RAMON BORRAS, Sant Cugat del Valles (ES)

(73) Assignee: Hewlett-Packard Development Company, L.P., Spring, TX (US)

(21) Appl. No.: 18/720,550

(22) PCT Filed: Dec. 16, 2021
(86) PCT No.: PCT/US2021/063742

§ 371 Date: Jun. 14, 2024

(51) Int. Cl. G01C 15/04

(52) U.S. Cl. CPC G01C 15/04

(57) ABSTRACT

Examples relate to systems and methods for tracking a marking device, and for determining a set of locations for a measurement station. A method comprises receiving site layout information including information of a plurality of marking targets, defining potential optical obstructions, and determining a station placement list from a plurality of potential station placement locations.

### BACKGROUND

A marking device may be positioned by using an optical measurement station while marking a site according to site marking instructions. The optical measurement station may aid in positioning the marking device when the marking device is within the measurement field of view of the optical measurement station.

### BRIEF DESCRIPTION OF THE DRAWINGS

Various example features will be apparent from the detailed description which follows, taken in conjunction with the accompanying drawings, wherein:

FIG. 1 is a block diagram of a method according to an example.

FIG. 2 is a block diagram of a method according to an example.

FIGS. 3A-3B are diagrams of a site layout according to an example.

FIG. 4 schematically illustrates a visibility indicator according to an example.

FIG. 5 schematically illustrates a placement list according to an example.

FIG. 6 is a schematic diagram of a grid according to an example.

FIG. 7 is a diagram of a visibility zone according to an example.

FIG. 8 is a block diagram of instructions included in a non-transitory machine-readable storage medium according to an example.

FIG. 9 represents a controller including a processor and a non-transitory machine-readable storage medium according to an example.

FIG. 10 schematically illustrates a system according to an example.

FIG. 11 schematically illustrates a system according to an example.

FIG. 12 is a block diagram of instructions included in a non-transitory machine-readable storage medium according to an example.

FIG. 13 represents a controller including a processor and a non-transitory machine-readable storage medium according to an example.

### DETAILED DESCRIPTION

The disclosure presents examples of systems, devices, and computer-implemented methods for determining a set of locations for an optical measurement station. The disclosure also presents examples of methods for employing a plurality of optical measurement stations to guide or track a marking device during a marking task.

Optical measurement stations (for example, total robotic stations also referred to as TRS stations) may be placed on a site such as a construction site to measure location data of an object. Some optical measurement stations may be placed on a site to measure location data of a marking device, such as an autonomous ground printer, and to send the measured location data to the marking device.

A site layout plan may include information of a plurality of marking targets to be marked by a marking device.

An optical measurement station may be communicatively connected to a marking device for guiding or tracking the marking device during the marking task, e.g., providing positioning information to the marking device. In this disclosure, guiding or tracking of a marking device by an optical measurement station refers to the providing, by the optical measurement station, of location information of the marking device to the marking device. The marking device may comprise an autonomous ground printer, and the optical measurement station may be communicatively connected to the ground printer for guiding the ground printer during a printing task. The ground printer may comprise an optical element such as a prism. The optical element may optically detect the ground printer on its field of view to determine a location of the ground printer. The optical measurement station may determine the location of the ground printer as the ground printer undergoes a displacement on a site during a printing task, and the optical measurement station may send the measured location to the ground printer. The location of the ground printer may be determined at a measurement frequency such that a number of location measurements are taken during a defined time period. The location of the ground printer may be sent to the ground printer at a location communication frequency such that a number of location measurements are sent to the ground printer during a defined time period. The ground printer may employ the location information determined by the optical measurement station to make displacement decisions during the printing task by, for example, comparing the measured location to a printing task target location, and undergoing a displacement along a direction that advances the ground printer towards, or along, the marking target location.

The site may be, for example, a construction site. There may be elements in the site that may obstruct the line of sight between the optical element of the optical measurement station and a marking target, thus preventing measurement of the location of the marking device by the optical measurement station. In a construction site, elements such as walls and columns may block a field of view between the optical measurement station and a measurement target. Thus, to complete a marking task comprising marking of a plurality or marking targets on a site, an operator of the optical measurement station may relocate the optical measurement station on the site multiple times, such that a marking target area or zone may be within the measurement field of view of the optical measurement station (thus rendering the optical measurement station able to determine the marking device location as it marks a marking target on the marking target area, zone, or location). This may also be referred to as a “setup” of the optical measurement station.

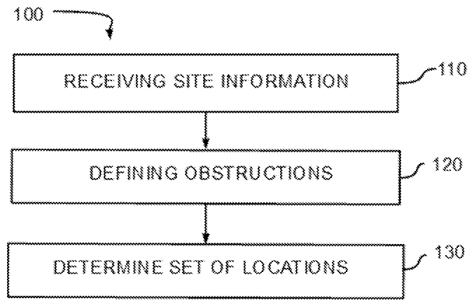

FIG. 1 is a block diagram of a computer-implemented method for determining a set of locations for an optical measurement station for guiding a marking device according to an example. The method 100 comprises receiving, at block 110, site layout information including location information of a plurality of marking targets. The site layout information may comprise, for example, a Computer-Aided Design (CAD) file, a graphical information file, digital data in any format representing graphical objects including relative positioning of the graphical objects (for example, coordinate information), or digital data representing a list of the graphical objects along with attributes thereof (such as object or element type, along with coordinates thereof provided in, for example, a relational table). In some examples, the set of locations is determined such that all marking targets are covered (that is, each marking target is visible from a location in the set of locations).

The marking targets may comprise printing targets. Location information of the plurality of marking targets may comprise, for example, absolute coordinates, relative coordinates, Cartesian coordinates, bidimensional coordinates, three-dimensional coordinates, or any combination thereof. In some examples, location information of the plurality of marking targets is obtained by scanning a CAD file. In some examples, location information of the plurality of marking targets is retrieved from a digital file.

The method 100 may comprise at block 120, defining potential optical obstructions to the optical measurement station in the site based on the site layout information. Optical obstructions to the optical measurement station refers to, for example, elements that may affect the measurement function of the optical measurement station due to blocking a line of sight or field of view between the optical measurement station and a measurement target of the optical measurement station.

Defining 120 may comprise employing image processing techniques to detect features. Image processing techniques to detect features may comprise, for example, vertex detection, corner detection, edge detection, or any combination thereof. Once a feature has been detected that corresponds to a potential optical obstruction, location information corresponding to the detected feature may be retrieved from the site layout information. In some examples, the site layout information is provided as digital information comprising pixel information and location information, wherein the location information may correspond to a single pixel or a plurality of pixels. In some examples, the site layout information is provided as digital information comprising voxel information and location information, wherein the location information may correspond to a single voxel or a plurality of voxels.

Defining 120 may comprise storing, for example, in a storage device such as a computer memory, the location information of the optical obstruction employing a respective identifier or label (e.g., opticalObstructionID) in a reference element such as a list or table. An optical obstruction element identified and stored accordingly may include location information such as coordinate values, for example, opticalObstructionID(x, y), wherein x, y may correspond to coordinates, e.g. Cartesian coordinates.

The method 100 further comprises determining, at block 130, a set of locations for placement of the optical measurement station on the site based on the plurality of marking targets and the defined potential optical obstructions. The set of locations may comprise one or more locations. In this disclosure “placement” refers to a location where an optical measurement station may be placed to perform a measurement or communication task(s). The set of locations may contain all the station placement locations necessary to guide the marking device as it performs marking tasks on a site.

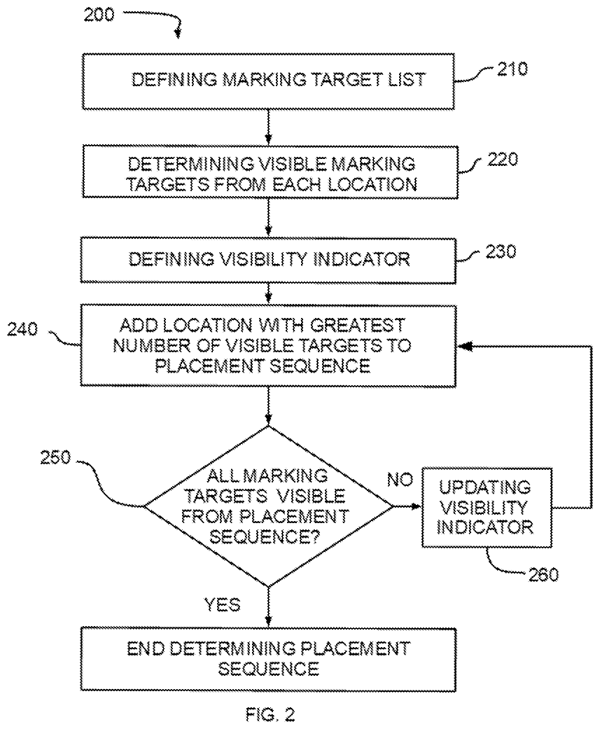

In some examples, determining a set of locations for placement of the optical measurement station on the site based on the plurality of marking targets and the defined potential optical obstructions comprises defining a plurality of station placement locations for placement of the optical measurement station on the site, and determining a placement list that produces a minimum number of optical measurement station placements to visibly reach all marking targets of the plurality of marking targets by the optical measurement station may factor in the location of the optical obstructions in the site layout information may be performed by a computing device. In this disclosure, to “visibly reach” or a “visible” (marking) target/location refers to a measurement target area or zone (such as a marking target location) that is within the field of view or line of sight of the optical measurement station (such that there are no optical obstructions between the optical measurements station and measurement target that would impede measurement of the location of the measurement target by the optical measurement station). The plurality of station placement locations refer to locations on a site where the optical measurement station(s) may potentially be placed or “set up”. A station placement location may be defined by location information. In some examples, a station placement location may be defined by relative coordinates or absolute coordinates. The coordinates may be defined, for example, on a Cartesian plane. In some examples, the coordinates comprise coordinate pairs of a bidimensional plane. In some examples, the coordinates comprise three coordinate values of a three-dimensional volume/space. The defined station placement locations are locations where the measurement station may potentially be placed or “setup”. FIG. 2 is a block diagram of a computer-implemented method 200 for determining a station placement list defining a sequential order of placement locations comprising defining, at block, 210, a marking target list comprising a plurality of marking targets and location information of the plurality of marking targets based on the site layout information.

Defining 210 the marking targets may comprise employing image processing techniques to detect certain features in the site layout information. For example, features such as vertices, edges, corners or combinations thereof, may be detected by, for example, employing vertex detection, corner detection, edge detection, or any combination thereof. Feature detection may comprise detecting features based on pixel intensity. Once a feature has been detected that corresponds to a potential optical obstruction, location information corresponding to the detected feature may be retrieved from the site layout information. In some examples, the site layout information may be provided as digital information comprising pixel information and location information, wherein the location information may correspond to a single pixel or a plurality of pixels.

A marking target may be defined based on location information of the marking target. For example, a marking target comprising a line segment having two opposing endpoints A and B, may be defined by coordinates of points A and B respectively (which may comprise, for example, bidimensional or three-dimensional coordinates), or may be defined by a plurality of coordinates corresponding to points along the line segment. A marking target defined by a plurality of coordinates may be provided in, for example, an array format. A marking target location may be defined according to its general shape. For example, a line segment may be defined by the two endpoints, while a generally circle-shaped marking target may be defined by a point(s) contained in a tangential line(s) to the circle originating from a reference point. Marking targets may comprise parts or segments of a monolithic marking element. For example, a site layout plan may comprise marking elements formed by a continuous line, such as a square shape or a circular shape. Such a shape or continuous line may be segmented into smaller marking targets (that is, defined as multiple segments which together form the entire marking element) for a marking task, for defining the marking target, and/or for determining visibility of the marking element or marking target.

The method 200 comprises determining at block 220, for each station placement location, the marking targets from the marking target list that may be visible from each station placement location. Marking targets that may be visible to a station placement location comprise those marking targets that are not optically obstructed from the line of sight or measurement field of view of an optical measurement station at the station placement location by an obstruction detected in the site layout information. Determining 220 for each station placement location, the marking targets from the marking target list that may be visible from each station placement location may comprise counting the marking targets from the marking target list that may be visible from each station placement location.

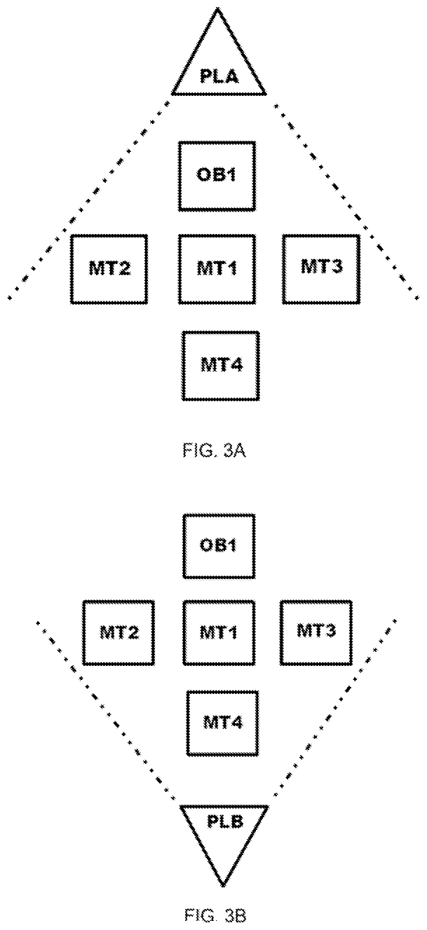

An example of a site layout including marking targets and potential optical obstructions is shown in FIGS. 3A and 3B. FIG. 3A is a representation of a site layout including marking targets MT1, MT2, MT3, and MT4, and an optical obstruction OB1. A plurality of potential station placement locations PLA, PLB, PLC, PLD, and PLE may be defined for potential placement of an optical measurement station based on the example site layout. Station placement locations PLA and PLB are shown in FIGS. 3A-3B (potential station placement locations PLC, PLD, PLE are not shown in FIGS. 3A-3B). Station placement location PLA has a measurement field of view represented by the intermittent lines. An optical measurement station placed at station placement location PLA may visibly reach marking targets MT1 and MT2, while marking targets MT3 and MT4 may not be reachable due to being obstructed by OB1. FIG. 3B shows the same site layout, and schematically illustrates a measurement field of view, represented by the intermittent lines, of station placement location PLB. An optical measurement station placed at location PLB may visibly reach all four marking targets MT1, MT2, MT3, MT4.

The method 200 comprises defining, at block 230, a visibility indicator indicating, for each station placement location, the marking targets visible from the station placement location (if any), and the total number of marking targets visible from the station placement location.

The method 200 may comprise adding 240 a station placement location with a greatest number of marking targets visible from that station placement location to a station placement list. Adding 240 may comprise referring to the visibility indicator to determine or identify the station placement location with a greatest number of visible marking targets.

The method 200 may comprise determining 250 whether any marking target in the marking target list is not visible from a station placement location in the placement list.

If it is determined at block 250 that there are marking targets from the marking target list that are not visible from a station placement location in the placement list, the method 200 may comprise updating 260 the visibility indicator to indicate the station placement locations not added to the placement list

In some examples, updating 260 the visibility indicator may comprise removing, from the visibility indicator, the station location that was added to the placement list and the marking targets visible from that station placement location. Removing the station placement location added to the placement list may comprise removing the station placement location identifier (along with the visible marking target information/identifiers visible from that location, and all instances of the visible market target identifier(s) from the visibility indicator. Thus, if a marking target MT1 is visible from locations PLA and PLB, and location PLA is added to the placement list, updating the visibility indicator may comprise removing PLA from the visibility indicator along with the visible marking targets listed for PLA, and further removing the reference to MT1 from the list of visible marking targets for PLB.

In some examples, updating 260 may comprise updating a flag of the visibility indicator. For example, the visibility indicator may comprise a flag (e.g., logical value flag), indicating, for each station placement location, whether that location has been added to the placement list) e.g., placement list flag). In a subsequent iteration of determining the placement list, the method may comprise referring to the updated placement list flag to determine whether a particular station placement location should be disregarded in determining a station placement location with a greatest number of visible marking targets (as it has already been added to the placement list).

The method 200 may comprise determining 260 whether there are marking targets in the marking target list that are not visible from a station location added to the station placement list, and, repeating, adding a station placement location from the updated visibility indicator with the greatest number of marking targets visible from the location to the station placement list and updating the visibility indicator; and determining whether there are marking targets in the marking target list that are not visible from the station locations in the placement list; until it is determined that the marking targets in the marking target list are visible from a station placement location in the placement list (until it is determined that the marking targets in the marking target list are visible from a station placement location in the placement list may comprise until it is determined that all the marking targets in the marking target list are visible from a station placement location in the placement list, or, it may comprise; until it is determined that a certain number of percentage of the marking targets in the marking target list are visible from a station placement location in the placement list. In some examples, blocks 240, 250, and 260 may be repeated until a certain predetermined number or percentage of marking targets from the marking target list is visible by the placement list. In some examples, blocks 240, 250, and 260 may be repeated until all the marking targets from the marking target list are visible by the placement list

Thus, the blocks 240, 250, and 260 may be repeated while there are marking targets from the marking target list that are not visible from a station placement location that has been added to the station placement list. Adding 240 a station placement location with a greatest number of marking targets visible from that location may comprise, for example, comparing the total number of marking targets visible from each station placement location in the visibility indicator, and/or ordering the station placement locations in the visibility indicator in descending (or ascending) order of total number of visible marking targets, and selecting a station placement location accordingly for adding to the placement list.

The visibility indicator may comprise, for example, a table(s), list(s), database(s), flag(s), matrix(ces), map(s), a data structure(s), a graphical or image element, or any combination thereof. The visibility indicator may comprise a format, such as a relational table format or a matrix format. The visibility indicator may comprise a field for listing the station placement locations and a field, for each listed station placement location, listing the marking targets visible from that station placement location. The visibility indicator may also include a field for listing a numerical value representing the total number of marking targets visible from each listed station placement location. The station placement locations and marking targets may each be elements identified, for example, in the visibility indicator, by an identifier, for example stationPlacementLocationID and markingTargetID labels respectively. The method may comprise storing, for example, in a storage device such as a computer memory, the location information of the plurality of station placement locations and the plurality of marking targets employing respective identifiers or labels (e.g., stationPlacementID; markingTargetID) in a reference element such as a list or table. Station placement locations and marking targets identified and stored accordingly may include location information such as coordinate values, for example, stationPlacementLocation(x, y); marking Target(x, y). In some examples, the total number of marking targets visible from each station placement location may be provided as a separate reference element (e.g., a separate list or table). The reference element may identify each station placement location with an identifier or label, and may include a numerical value representing the total number of marking targets visible from that station placement location (for example, stationPlacementLocationID(n)). In some examples, a station placement location element includes an identifier, location information, and the total number of marking targets visible from the station placement location (e.g., stationPlacementID((x, y); n)). If provided as separate tables or lists, a pointer, a linking, or referencing element may be employed to associate the different tables or lists and their respective fields.

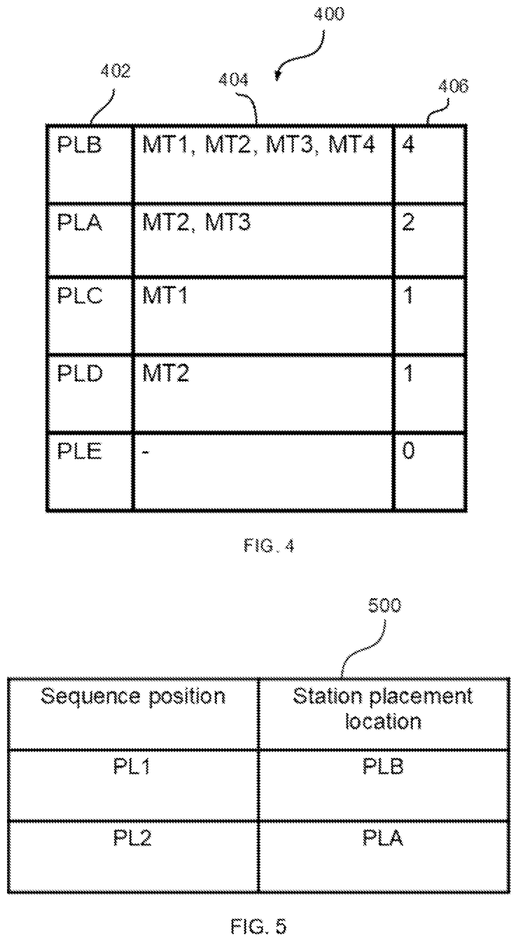

A schematic example of a visibility indicator comprising a visibility table 400 for the example site layout of FIGS. 3A-3B is shown at FIG. 4. The visibility table 400 identifies, in field 402, each station placement location PLA, PLB, PLC, PLD, and PLE, and for each of the station placement locations PLA, PLB, PLC, PLD, and PLE the table 400 indicates, in field 404, the marking targets (from an example marking target list comprising marking targets MT1, MT2, MT2, and MT4) visible from that location. Each of the marking targets may be indicated by a marking target identifier or label (for example, MT1, MT2, MT3, and MT4). The table 400 may also include a field 406 for indicating a numerical value representative of the number of targets visible from each station placement location listed in field 402. The visibility indicator may be stored in a storage device such as a computer memory.

An example placement list 500 is shown at FIG. 5. The example placement list is based on the site layout example of FIGS. 3A-3B. According to an example, it is determined based on the example visibility table 400 that, of the plurality of station placement locations PLA, PLB, PLC, PLD, PLE and, station placement location PLB has a greatest number of visible marking targets. Thus, PLB is added to the placement list 500. In some examples, the placement list is defined by positions having a sequential order, such that the first station placement location that is added to the list is assigned to a first position in the placement list, and the second station placement location that is added to the list is assigned to a second position in the placement list that is sequentially follows the first position. As shown in the example list 500, the location PLB may be assigned to a first position PL1 in the placement list 500. The additional station placement location PLA covers visible marking targets not visible by PLB, and covers more visible targets than the other potential station placement locations. Thus, it may be added to the placement list at a second position PL2. An optical measurement station placed at the station placement locations according to the placement list (that is, first placed at the station placement location in position PL1 and then relocated to the position in position PL2 of the placement list) will visibly reach all of the plurality of marking targets. Thus, a station placed according to the placement list may be optically coupled to the marking device throughout the marking of each marking target on a site.

In some examples the placement list is defined as a list, table, data structure, matrix, graphical element or any combination thereof. In some examples, the placement list may be stored in a storage device such as a computer memory. The stored placement list may be updated each time a new station placement location is added to the placement list.

In some examples, defining a plurality of station placement locations comprises defining a grid plurality of station placement locations, wherein the dimensions of the grid are defined based on the site layout information. The grid may comprise a plurality of cells, wherein each cell is defined by one of the plurality of locations and has a dimension according to a grid resolution.

In some examples, defining the grid may comprise obtaining dimension information of the site or site layout. For example, a grid may be defined to have maximum width and length dimensions (for example, by defining grid edge coordinates) based on the site layout information, and the plurality of station placement locations may be defined to lie within the defined maximum dimensions (or defined grid edge coordinates) of the grid. Each of the plurality of station placement locations on the grid may be defined by, for example, coordinate values defined in the grid. A grid reference location may be selected based on (architectural) elements on the site. The plurality of station placement locations may be defined with reference to the grid reference location. The grid may be defined to comprise relative coordinates, absolute coordinates, or any combination thereof. In some examples defining the grid may comprise selecting a resolution (for example, a uniform spacing between the plurality of station placement locations defined in the grid). In some examples, the resolution may be selected or determined based on site or site layout characteristics. For example, a site layout may include (architectural) elements of a size or dimension, or a density thereof, which may not allow for a distance or spacing between adjacent station placement locations of the plurality of station placement locations of less than 1 meter. In that case, a resolution (e.g., distance or spacing between adjacent station placement locations) may be selected to be more than 1 meter (for example, 1.5 or 2 m). The plurality of station placement locations may be defined according to the selected or determined resolution. The selected or determined resolution may be based on the of the accuracy of the optical measurement station.

In some examples, the grid (and cells thereof, if any) may be defined employing three dimensions (width, length, and height) to represent a volume.

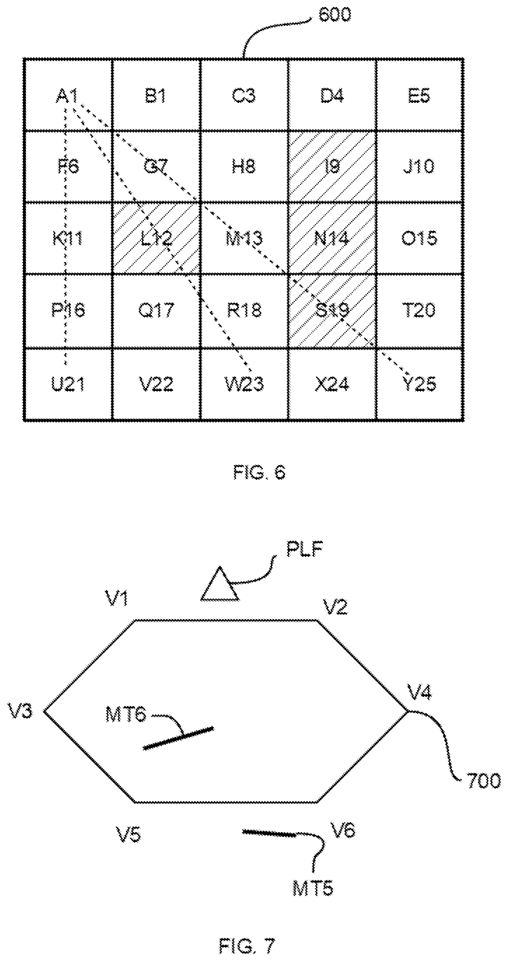

A schematic diagram of a grid 600 according to some examples is shown at FIG. 6.

In the example bidimensional grid 600, each cell represents a station placement location represented by a letter (A, B, ( . . . ); Y) and defined by a coordinate pair (x, y) defined substantially at the geometrical center of the cell. In the example, the numbers in the non-patterned cells represent a marking target (location) in the cell. Moreover, patterned cells L12, I9, N14, and S19 represent optical obstructions. The coordinate pair values defining a station placement location and the coordinate pair values defining a marking target may be employed to determine whether there is an unobstructed line of sight between the station location and the marking target that would allow for measurement in the marking target area or zone. Such determination may take into account the coordinate pair values of the (potential) optical obstructions. A plurality of geometrical rays originating at location A (x, y) may intersect a number of marking target locations and/or a number of obstruction locations. In some examples, determining whether an intersection point encountered by a ray originating at location A (x, y) corresponds to a marking target location or to an obstruction location may be employed to determine whether a certain marking target may be visible to an optical measurement station placed at location A (x, y). In the example of FIG. 6, a first ray intersects marking target locations 6, 11, 16, 21 and does not intersect an obstruction location prior to intersecting any of marking targets 6, 11, 16, and 21. Therefore, marking targets 6, 11, 16, and 21 may be determined to be visible from location A (and thus optical measurement station placed at location A may be able to track a marking device during marking of marking targets 6, 11, 16 and 21). A second ray intersects marking targets 6 and 7, and continues on to intersect obstruction L12. In this case, marking targets 17, 18, and 23, while intersected by the second ray, are obstructed by L12 and are thus not visible from location A(x, y). Similarly, the line of sight to target 25 from location A(x, y) is obstructed by S19.

In some examples, determining the visible marking targets from a station placement location may comprise determining a geometrical intersection point(s) (e.g., coordinate pair values) between a geometrical line, ray or vector originating at the location (e.g., coordinate values) of the station placement location (e.g., mathematically and/or geometrically defined with the numerical values of that coordinate pair), and elements (such as optical obstructions or marking targets, also represented by coordinate pairs) within the field of view of a station. The geometrical lines, rays or vectors may be representative of a “line of sight” of an optical measurement station placed at the origin point of the geometrical ray, line or vector. The (measurement) field of view of the optical measurement station may be geometrically defined or demarcated by location information on a plane of space (for example, a plurality of coordinate values). The elements in the field of view from a particular station placement location may comprise, for example, marking targets and/or optical obstructions. Once intersection point(s) along the ray are determined (if any), it may be determined whether the intersection point(s) that is most proximate to the origin point of the ray (wherein the origin point is representative of the the station placement location) corresponds to a marking target or an optical obstruction. In some examples, marking targets and optical obstructions are stored in e.g., a computer memory, employing an identifier and their respective location information. The method may comprise referring to the optical obstruction and marking target identifier and location information to determine whether intersection point(s) correspond to one of the marking targets and/or one of the obstruction elements.

In some examples, the boundaries of the grid (for example, location or coordinate values representing the maximum width extension, length extension, and, in the case of three-dimensional grid, also the maximum height extension of the grid) may be employed to demarcate the field of view of a station placement location. The identified intersection points may also be employed to determine or identify the elements that are beyond (in a direction away from the station placement location) the first or most proximate intersection point to a station placement location and thus obstructed.

In some examples, defining potential optical obstructions comprises detecting architectural elements or solid surfaces in the site layout information; and obtaining location information of the detected architectural elements, and the method comprises defining an optical obstruction location based on the obtained location information of the detected architectural elements. Examples of architectural elements that may pose an optical obstruction to the optical measurement station and may be detected according to the method include walls, columns, pipes, etc.

In some examples, an optical obstruction (for example, an architectural element) that comprises a line segment having two endpoints may be defined by location information of the two endpoints (e.g., coordinate values) of the line segment, or the optical obstruction may be defined by a plurality of points along the line segment. In some examples, defining an optical obstruction comprising a line segment, arc, curved, circular or other geometrical shape, comprises defining a polygon (or combination of polygons) including or containing the optical obstruction shape (for example by extrapolating location information of the optical obstruction or optical obstruction shape). The polygon (or combination of polygons) may be defined by the vertex points of the polygon (or exterior vertices in the case of a combination of polygons). Defining a polygon may comprise determining point(s) tangential to (parts of) the geometrical shape of the optical obstruction geometrical shape/location.

In some examples, the method comprises determining a visibility zone for each station placement location based on the grid and the defined optical obstructions.

In some examples, a visibility zone for each station placement location is determined based on the grid and the defined optical obstructions and comprises determining, for a plurality of geometrical rays (or geometrical lines or vectors) originating from the station placement location, a most proximate element or a most proximate (first) intersection point with an element (for example, a defined optical obstruction or grid boundary defined by coordinate values); and demarcating the visibility zone of the station placement location based on the location information of the most proximate element (or first intersection point with an element) of each of the plurality of geometrical rays. The plurality of geometrical rays may be defined to be spaced at an angular interval (e.g., angular distance or angular separation) defined along, for example, a 360-degree angular range around the origin point (e.g., the station placement location information or coordinate values). For example, rays may be defined at a plurality of points separated by 5 degrees around the station placement location. In some examples, a station placement location may be defined to comprise an angular range of 360 degrees. In some examples, an angular range of a station placement location for purposes of defining the plurality of geometrical rays may be defined to be less than 360 degrees based on its location with respect to the grid boundaries. For, example, a station placement location defined at an edge location of the grid may have a limited potential field of defined by a maximum angular range of 180 degrees. The angular range employed for defining the plurality of rays may be defined based on the grid or dimension of the site layout and the station placement location of the station placement location in relation to the grid.

A visibility zone may comprise, for example, a bidimensional visibility area or a three-dimensional visibility volume. A “visibility zone” or a “visibility area” in this disclosure refers to a geometrical representation of a spatial zone or area defining the measurement range of an optical measurement station placed at a particular location, taking into account optical obstructions. The plurality of geometrical rays may each be defined by a first (origin) point at the station placement location defined by coordinate values and may represent a line of sight (for measurement) from the station placement location along the direction of the ray. In some examples, the plurality of rays (or geometrical lines or vectors), plurality of station placement locations, and plurality of marking target locations are defined on the same geometrical plane.

In some examples, the method comprises employing a first coordinate pair (e.g., of a station placement location), and a second coordinate pair (e.g., of an optical obstruction limiting the measurement field of view of the station placement location at the first coordinate pair) to determine whether the marking target location coordinate pair is within a line of sight defined as a geometrical line between the two coordinate pairs.

In some examples, the method comprises employing a ray casting algorithm to determine which marking targets from the marking target list are visible from each station placement location of the plurality of station placement locations.

In some examples, the method comprises determining the element(s) locations visible to a station placement location along a direction by employing a ray casting algorithm to obtain indication of an intersection point of a geometrical ray or line (representative of a line of sight) with an element defined by a location. The elements defined by locations (e.g., coordinate values) may include marking targets, optical obstructions and/or grid boundaries.

In some examples, the method comprises determining the most proximate element(s) locations to a station placement location along a direction by employing a ray casting algorithm to obtain indication of an intersection point of a geometrical ray or line (representative of a line of sight) with an element defined by a location. The most proximate element(s) defined by locations (e.g., coordinate values) may include marking targets, optical obstructions and/or grid boundaries. A most proximate element may comprise an architectural element such as a column or wall.

A visibility zone 700 defined according to some examples is shown at FIG. 7. The visibility zone 700 may be defined as a plurality of vertices (V1, V2, V3, V4, V5, and V6) of a polygon defining the unobstructed measurement field of view from a station placement location. Each vertex may be defined by location information, for example, coordinate values. Determining the marking targets that are visible from a station placement location may comprise employing a point in polygon (PIP) algorithm to determine whether the marking target location is within the visibility zone of the station placement location. For example, the method may comprise determining the number of times a geometrical ray, line or vector intersects (a segment of) the polygon, and in examples, if the number of intersection points between the ray and the polygon is odd it indicates that the marking target location is within the polygon (within the measurement field of view), and, if the number of times of intersection points between the ray and the polygon is even, it indicates that the marking target location is outside the polygon (field of view). Location information of potential optical obstructions (and grid “boundary” location information) may be employed to define a polygon or combination of polygons defining the unobstructed measurement field of a view of a station placement location. The polygon or combination of polygons may be defined by vertex point location information (for example, coordinate values of the vertices of the polygon). In the case of a measurement field of view defined by a combination of polygons, the exterior vertex points may be employed to define the measurement field of view of the station placement location. The PIP algorithm may employ the polygon vertex point location information and the marking target location information as input values to determine whether the marking target location is within the measurement field of view of a station placement location. The PIP algorithm may output an output value indicating a determination as to whether the marking target location is inside or outside the measurement field of view polygon of the station placement location.

In some examples, determining a visibility zone for a station placement location by defining the vertices of a polygon (for use in the PIP algorithm) may comprise determining, for a plurality of geometrical rays originating from each station placement location, a most proximate element or most proximate intersection with an element of the station placement location along a direction of each of the plurality of geometrical rays; and defining vertex points of the visibility zone of the station placement location based on location information of the most proximate element or first intersection with an element along a direction of each of the plurality of geometrical rays. In some examples, determining a visibility zone for a station placement location by defining the vertices of a polygon (for use in the PIP algorithm) comprises determining the most proximate element or most proximate intersection with an element and employing a ray casting algorithm to obtain location information of an intersection point of each of the plurality of geometrical rays with a most proximate element.

In some examples, determining the marking targets that are visible from a station placement location comprises employing a ray casting algorithm to determine whether the marking target location is within the visibility zone of the station placement location.

In some examples, the marking target locations and plurality of placement station locations are defined by bidimensional coordinate pairs (e.g., x, y), and the ray casting algorithm may be implemented based on a bidimensional coordinate values (for example, wherein the marking targets and potential station placement locations are defined on a single plane of the site layout, e.g., a horizontal plane). In some examples, the marking target locations and plurality of placement station locations are defined by three-dimensional coordinates (e.g., x, y, z), and the ray casting algorithm may be implemented based on three-dimensional coordinate values (for example, wherein the marking targets and station placement locations are defined on horizontal and vertical planes of the site layout). In some examples, an input value to the ray casting algorithm may comprise an input value indicating coordinate values of a first station placement location, an input value indicating coordinate values demarcating a field of view from the first station placement location, and an input value indicating coordinate values representative of optical obstructions, and the output value of the ray casting algorithm may comprise an output value indicating the presence of absence of an intersection between the field of view of the first station placement location and the optical obstruction based on the input values. The input values may be provided as an array of input values. The output value may comprise an intersection flag indicating whether an intersection exists between the elements represented by the input values. The output value may comprise coordinate values of, for example, an intersection point(s).

In some examples, the method comprises defining each of the plurality of marking targets based on their location information. For example, a marking target that comprises a line segment having two endpoints may be defined by location information of the two endpoints (e.g., coordinate values) of the line segment, or the marking target may be defined by a plurality of points along the line segment. In some examples, defining a marking target comprising a line segment, arc, curved, circular or other geometrical shape, comprises defining a geometrical shape, for example, a polygon (or combination of polygons) including or containing the marking target shape (for example by extrapolating location information of the marking target or marking target shape). The polygon (or combination of polygons) may be defined by the vertex points of the polygon (or exterior vertices in the case of a combination of polygons). Defining a polygon may comprise determining point(s) tangential to (parts of) the geometrical shape of the marking target geometrical shape/location.

In some examples, the method comprises, if an additional station placement location has a greatest number of visible targets (e.g., two or more station placement locations have the same cardinality), defining an additional station placement list or list for each additional station placement location having a greatest number of visible marking targets. Each placement list may be finalized (that is, the placement list is defined such that the marking targets on a marking target list are visible from a station placement location added to the placement list) according to the methods described in this disclosure. Once each placement list is finalized, the method comprises determining the total number of station placement locations in each placement list to determine a placement list with a minimum number of station placement locations. A placement list with a minimum number of station placement locations may be employed for operating an optical measurement station during a measurement task.

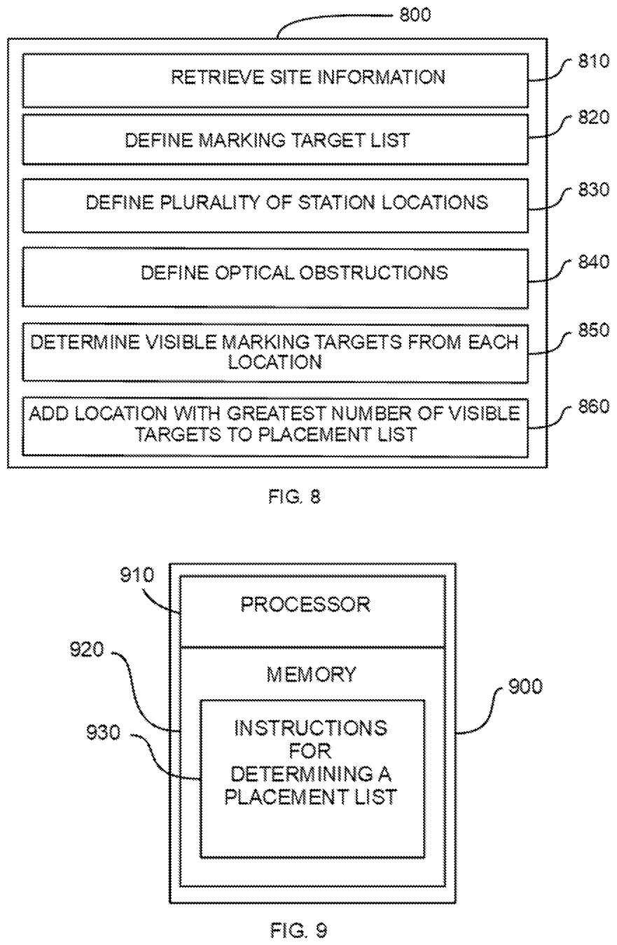

FIG. 8 shows an example non-transitory machine-readable storage medium as provided according to some examples. The non-transitory machine-readable storage medium is encoded with instructions 800 which, when executed by a processor, cause the processor to retrieve 810 site layout information; define 820 a marking target list comprising a plurality of marking targets and their location information based on the site layout plan; define 830 a plurality of station placement locations on the site for the optical measurement station based on the site layout plan; define 840 potential optical obstructions to the optical measurement station based on the received site layout information; determine 850, for each station placement location of the plurality of station placement locations, the marking targets from the marking target list visible from the placement location and the total number of marking targets that are visible from the station placement location; and add 860 a station placement location with the greatest number of visible marking targets to a station placement list.

In some examples, the non-transitory machine-readable storage medium is encoded with instructions which, when executed by a processor, cause the processor to add a station placement location with a greatest number of marking targets visible from that location to a station placement list; and determine whether there are marking targets in the marking target list that are not visible from a station location added to the station placement list, and, if there are marking targets in the marking target list that are not visible from the station locations in the station placement list, to update the visibility indicator and to repeat adding a station placement location of the station placement locations in the updated visibility indicator with a greatest number of marking targets visible from the location to the station placement list and updating the visibility indicator; until it is determined that all marking targets in the marking target list are visible from a station placement location in the placement list.

In some examples, the station placement list may comprise a station placement sequence defining a sequential order of station placement locations from the plurality of potential station placement locations that produces a minimum number of optical measurement station placements to reach the marking targets of the plurality of marking targets with a measurement field of view the optical measurement station.

In some examples, the non-transitory machine-readable storage medium is encoded with instructions which, when executed by a processor, cause the processor to define potential optical obstructions by detecting architectural elements in the site layout information; and obtaining location information of the detected architectural elements, and defining an optical obstruction location based on the obtained location information of the detected architectural elements.

Updating the visibility indicator may comprise removing the station placement location added to the placement list and the instances of the marking targets visible from that station placement location from the visibility indicator (for example, removing reference to the marking targets visible from the station placement location from the visibility information of the station placement locations remaining in the updated visibility indicator, such that the already visible marking targets are not counted in subsequent iterations of determining, from the visibility indicator, a station placement location with a greatest number of visible marking targets).

FIG. 9 represents a controller 900 according to some examples, including a processor 910 and a memory 920 including instructions 930 to determine a station placement list. In some examples, the instructions to determine a station placement list may comprise instructions to determine a sequential order of station placement locations from the plurality of potential station placement locations that produces a minimum number of optical measurement station placements to reach the marking targets of the plurality of marking targets with the measurement field of view of the optical measurement station coupled to the processor. The instructions 930 may comprise instructions 800 described in relation to FIG. 8.

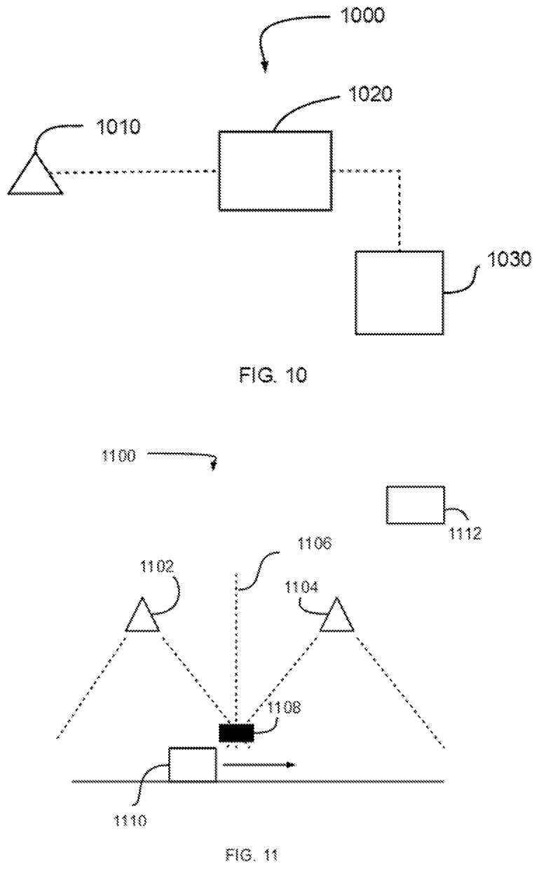

A system 1000 according to some examples is shown at FIG. 10. The system 1000 comprises a controller 1020 as described in relation to FIG. 9, to determine a station placement list for an optical measurement station 1010 for a marking device 1030.

In some examples, the placement list may comprise a sequential order of station placement locations from the plurality of potential station placement locations that produces a minimum number of optical measurement station placements to reach the marking targets of the plurality of marking targets with the measurement field of view of the optical measurement station 1010. The controller 1020 may comprise controller 900 described in relation to FIG. 9.

In some examples, the system 1000 may comprise a marking device (such as a ground printer) 1030. In some examples, the system may comprise a plurality of marking devices 1030.

In some examples, the controller 1020 is to define a marking target list comprising the plurality of marking targets and their location information based on information of a site layout; define a plurality of potential placement locations for the optical measurement station; define potential optical obstructions to the optical measurement station based on the information of the site layout; determine, for each station placement location of the plurality of potential station placement locations, the marking targets from the marking target list visible from the station placement location and the total number of visible marking targets; and add a station location with a greatest number of visible marking targets to a station placement list. Optical obstructions refers to elements which may potentially obstruct the measurement field of view of an optical measurement station.

In some examples, the controller 1020 may comprise instructions 800 as described in relation to FIG. 8.

FIG. 11 schematically illustrates a system 1100 according to some examples. The system 1100 may comprise a marking device controller 1112 to cause the marking device 1110 to receive marking device location information from a first optical measurement station 1102 during a first time period and to receive marking device location information from a second optical measurement station 1104 during a second time period. Thus, the marking device controller 1112 may control the marking device to stop receiving marking device location information from the first optical measurement station 1102 and control the marking device to start receiving marking device location information from the second optical measurement station 1104 after the end of tracking by the first optical measurement station 1102. The first and second marking tasks may comprise marking parts of the same marking element (for example, a continuous line segment) or may comprise separate markings. The first optical measurement station 1102 may be at a first location and the second optical station may be at a second location. The first and second marking tasks may be defined by respective location information. The switch in the tracking of the marking device 1110 from a first optical measurement station 1102 to a second optical measurement station 1104 may be triggered by, for example, the location of the marking device 1110, a change in a strength of a marking device location information signal received by the marking device, or a combination thereof (for example, a decrease in an average or root mean square voltage value of the location information signal over a period of time). According to some examples, the system 1100 may additionally comprise a controller 1020 as described in relation to FIG. 10. In some examples, the system 1100 may comprise the marking device 1110. The marking device 1110 may comprise a ground printer.

In some examples, the marking device controller 1112 is provided integrally with the marking device 1110. In some examples, the marking device controller 1112 is provided separately from the marking device 1110.

In some examples, tracking of the marking device 1110 by the first and second optical measurement stations may overlap during a period of time. Thus, in some examples the marking device may receive location information simultaneously from multiple optical measurement stations. In some examples, the marking device may employ an average or a weighted average of the location information received from multiple optical measurement stations. This may, for example, prevent disruptions in the tracking of the marking device 1110 during a marking task.

The marking device controller 1112 may comprise a plurality of controllers 1112, each provided integrally with a marking device. In some examples, the marking device controller 1112 is a single controller employed to control a plurality of marking devices (which single controller may be provided separately from the plurality of marking devices). The marking device controller 1112 may comprise a distributed controller and/or a plurality of controllers. The ground printer controller 1112 may comprise a controller, plurality of controllers, and/or distributed controller(s) stored remotely, such as a remote server(s) stored in cloud storage provided via cloud computing. The marking device controller 1112 may comprise a controller, plurality of controllers, and/or distributed controller(s) provided remotely or locally on a computing device.

The marking device controller 1112 may comprise a ground printer controller. The marking device controller 1112 may comprise a ground printer controller 1300 as shown in FIG. 13.

In some examples, the marking device controller 1112 is to control the marking device 1110 to receive marking device location information from a first optical measurement station 1102 during a first time period and to receive marking device location information from the second optical measurement station during a second time period. The marking device 1110 may carry out a continuous marking or printing during the first and second time periods.

In some examples, the marking device controller 1112 is to control the marking device 1110 to receive marking device location information from a first optical measurement station 1102 during a first marking task and to control receive marking device location information from a second optical measurement station during a second marking task. The first and second marking tasks may comprise marking parts of the same marking element (for example, a continuous line segment) or may comprise separate markings. The first optical measurement station 1102 may be at a first location and the second optical station may be at a second location. The first and second marking tasks may be defined by respective location information.

In some examples, the marking device controller 1112 may be communicatively connected to the first and second optical measurement stations or to the marking device by, for example, a Bluetooth communication connection. In some examples, the first and second stations may be communicatively connected to each other via, for example, a Bluetooth communication connection. The marking device controller 1112 may be to cause a switch or handover of the guiding of the marking device between the optical measurement stations based on a distance or location value. In some examples, the guiding switch between the optical measurement stations may be based on reference location information of the optical measurement stations and on location information of the marking device. For example, the location information may comprise a measurement field of view of each optical measurement station. In some examples, the reference location information may comprise a visibility zone determined according to a method(s) described in this disclosure. The marking device controller 1112 may receive location information of the marking device from the first optical measurement station and may compare the received location information of the marking device to a reference value (e.g., visibility zone information of the first and/or second optical measurement stations). If the comparison indicates that the marking device is no longer within the visibility zone or measurement field of view of the first optical measurement station (or that the marking device is approaching an end boundary of the measurement field of view of the first optical measurement station), the controller may cause a switch in guiding of the marking device from the first optical measurement station to a second optical measurement station with a measurement field of view that can a reach the (new) location of the marking device. In example at FIG. 11, intermittent line 1106 indicates a boundary between the measurement fields of view (the fields of view are indicated by the intermittent lines originating at optical measurement stations 1102 and 1104). The measurement fields of view of a plurality of optical measurement stations may overlap.

In some examples, the change of tracking may be based on a threshold, for example, if the marking device controller 1112 detects that the marking device 1100 is within a distance d from a field of view boundary, it may control to cause a change of the optical measurement station tracking the device or it may program the change to begin at particular time. In some examples, the change in tracking station may be based on a strength of the location information signal received by the marking device.

In the example, an obstruction 1108 causes a disruption in the measurement field of view of optical measurement station 1102 as the marking device 1110 displaces itself along the travel direction indicated by the arrow. Once the marking device controller 1112 receives an indication (for example, comparison result between a marking device location and an optical measurement station reference measurement field of view location), the marking device controller 1112 may control the marking device to cause a switch in tracking of the marking device from the first optical measurement station 1102 to the second optical measurement station 1104. The marking device controller 1112 may alternatively or additionally control the marking device 1110 to cause a switch in tracking of the marking device from the first optical measurement station 1102 to the second optical measurement station 1104 according to the methods described in this disclosure.

In some examples, the first and second optical measurement stations 1102, 1104 are placed at station placement locations according of a placement list determined by a method(s) described in this disclosure.

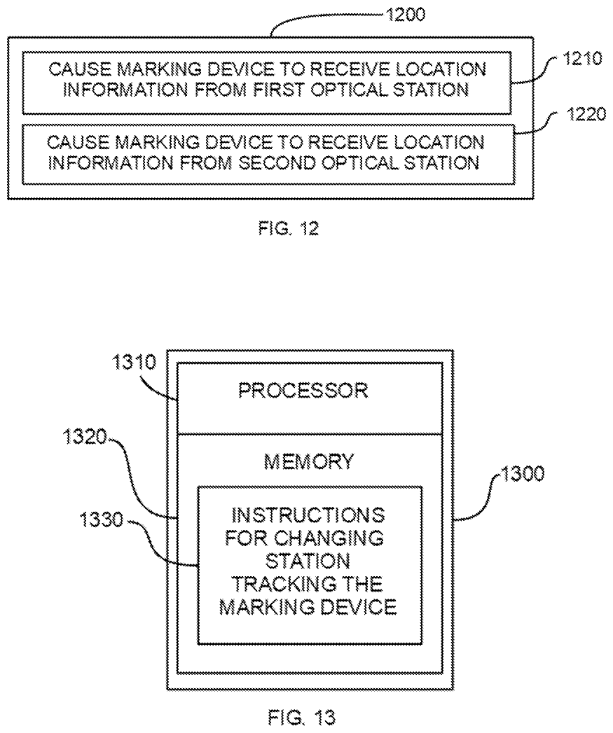

FIG. 12 shows an example non-transitory machine-readable storage medium as provided according to some examples. The non-transitory machine-readable storage medium is encoded with instructions 1200 which, when executed by a processor, cause 1210 the processor to cause a marking device to receive marking device location information from a first optical measurement station during a first time period and to receive marking device location information from a second optical measurement station during a second time period. The first optical measurement station may be at a first location and the second optical measurement station may be at a second location. The first location and the second location may be defined by a station location set, or a station location placement list or list according to the example methods described herein. A number of optical measurement stations may be provided at different placement locations on the site. The locations or “setups” may correspond to locations defined in a station placement list, for example, a placement list determined to produce a minimum number of placements according to the example methods described in this disclosure. The processor may receive location information of the marking device, and the instructions 1200 may cause a switch in tracking of the marking device from a first optical measurement station at a first location to a second optical measurement station at a second location based on the marking device reaching or approaching a location within the field of view of the second measurement station. The switch may be executed any number of times, between a plurality of stations, to complete a marking task on a site.

FIG. 13 represents a ground printer controller 1300 according to some examples, including a processor 1310 and a memory 1320 including instructions 1330 to cause the processor to cause a first optical measurement station to track a marking device during a first time period and cause a second optical measurement station to track the marking device during a second time period. The ground printer controller 1300 may comprise a distributed controller and/or a plurality of controllers. The ground printer controller 1300 may comprise a controller, plurality of controllers, and/or distributed controller(s) stored remotely, such as a remote server(s) stored in cloud storage provided via cloud computing. The ground printer controller 1300 may comprise a controller, plurality of controllers, and/or distributed controller(s) provided remotely or locally on a computing device. The instructions 1330 may comprise instructions 1200 as described in relation to FIG. 12. According to some examples, a system for controlling a ground printer is provided comprising a ground printer controller 1300. In some examples, the system for controlling a ground printer may additionally comprise a controller 1020 as described in relation to FIG. 10. In some examples, the system for controlling a ground printer may additionally comprise a ground printer.

In some examples, a method is provided for controlling a marking device to receive marking device location information from a first optical measurement station during a first marking task and to receive marking device location information from a second optical measurement station during a second marking task. The first and second marking tasks may comprise marking parts of the same marking element (for example, a continuous line segment) or may comprise separate markings. In the case of a continuous marking element, switching between optical measurement stations placed at different locations (as opposed to repositioning a single optical measurement station from a first location to a second location) may increase the quality of the marking or printing element by, for example, yielding a more continuous marking or printing.

The method may cause a switch or handover of the guiding of the marking device between the optical measurement stations based on a distance or location value. In some examples, the guiding switch between the optical measurement stations may be based on reference location information of the optical measurement stations and on location information of the marking device. For example, the location information may comprise a measurement field of view of each optical measurement station. In some examples, the reference location information may comprise a visibility zone determined according to a method(s) described in this disclosure. The method may comprise receiving location information of the marking device from the first optical measurement station, and the method may comprise comparing the received location information of the marking device to a reference value (e.g., visibility zone information of the first and/or second optical measurement stations). If the comparison indicates that the marking device is no longer within the visibility zone or measurement field of view of the first optical measurement station (or that the marking device is approaching a boundary of the measurement field of view of the first optical measurement station), a switch may be caused in guiding of the marking device from the first optical measurement station to a second optical measurement station with a measurement field of view that can a reach the (new) location of the marking device.

The non-transitory machine-readable storage media comprising instructions described in this disclosure may include any electronic, magnetic, optical, or other physical storage device that stores executable instructions. The non-transitory machine-readable storage medium may be, for example, Random Access Memory (RAM), an Electrically-Erasable Programmable Read-Only Memory (EEPROM), a storage drive, an optical disk, and the like.

The preceding description has been presented to illustrate and describe certain examples. Different sets of examples have been described; these may be applied individually or in combination, sometimes with a synergetic effect. This description is not intended to be exhaustive or to limit these principles to any precise form disclosed. Many modifications and variations are possible in light of the above teaching. It is to be understood that any feature described in relation to any one example may be used alone, or in combination with other features described, and may also be used in combination with any features of any other of the examples, or any combination of any other of the examples.

1. A computer-implemented method for determining a set of locations for placement of an optical measurement station for a marking device, comprising:
receiving site layout information including location information of a plurality of marking targets on a site;
defining potential optical obstructions to the optical measurement station in the site based on the site layout information;
and
determining a set of locations for placement of the optical measurement station on the site based on the plurality of marking targets and the defined potential optical obstructions.

2. The computer-implemented method of claim 1, wherein determining a set of locations for placement of the optical measurement station on the site based on the plurality of marking targets and the potential optical obstructions comprises:
defining a plurality of station placement locations for potential placement of the optical measurement station; and
determining a station placement list from the plurality of station placement locations that produces a minimum number of optical measurement station placements to reach the marking targets of the plurality of marking targets with the measurement field of view of the optical measurement.

3. The computer-implemented method of claim 2, comprising:
defining a marking target list comprising the plurality of marking targets and location information of the plurality of marking targets based on the site layout information;
determining, for each station placement location, the marking targets from the marking target list visible from the station placement location; and
defining a visibility indicator for indicating the marking targets and total number of marking targets visible from each station placement location of the plurality of station placement locations.

4. The computer-implemented method of claim 3, comprising:
adding a station placement location with a greatest number of marking targets visible from that location to the placement list; and
determining whether there are marking targets in the marking target list that are not visible from a station placement location added to the placement list, and,
repeating,
updating the visibility indicator to indicate the station placement locations not added to the placement list;
adding a station placement location of the station placement locations in the updated visibility indicator with a greatest number of marking targets visible from the station placement location to the station placement list; and
determining whether there are marking targets in the marking target list that are not visible from the station locations in the station placement list;
until it is determined that the marking targets in the marking target list are visible from a station location in the placement list.

5. The computer-implemented method of claim 1, wherein defining potential optical obstructions comprises:
detecting architectural elements in the site layout information; and
obtaining location information of the detected architectural elements, and wherein the method comprises defining an optical obstruction location based on the obtained location information of the detected architectural elements.

6. The computer-implemented method of claim 3, wherein defining a visibility indicator comprises determining a visibility zone for each station placement location.

7. The computer-implemented method of claim 6, wherein determining a visibility zone for each station placement location comprises:
determining, for a plurality of geometrical rays originating from each station placement location, a most proximate element or most proximate intersection with an element of the station placement location along a direction of each of the plurality of geometrical rays;
and
defining vertex points of the visibility zone of the station placement location based on location information of the most proximate element or first intersection with an element along a direction of each of the plurality of geometrical rays.

8. The method of claim 7, wherein determining the most proximate element or most proximate intersection with an element comprises employing a ray casting algorithm to obtain location information of an intersection point of each of the plurality of geometrical rays with a most proximate element.

9. The computer-implemented method of claim 6, wherein determining a visibility zone comprises defining a polygon, and wherein determining the marking targets that are visible from a station placement location comprises employing a point in polygon (PIP) algorithm to determine whether the marking target location is within the visibility zone of the station placement location.

10. The computer implemented method of claim 3, wherein determining the
marking targets that are visible from a station placement location comprises employing a ray casting algorithm to determine whether the marking target location is within the visibility zone of the station placement location.

11. The computer-implemented method of claim 4, wherein, if an additional station placement location has a greatest number of visible marking targets, defining an additional station placement list for each additional station placement location having a greatest number of potential locations, finalizing each additional placement list, and
comparing the number of station placement locations in each finalized placement list; and selecting a placement list with a minimum number of station placement locations.

12. A system comprising:
a controller to:
define a marking target list comprising a plurality of marking targets and their location information based on information of a site layout;
define a plurality of station placement locations for potential placement of an optical measurement station;
define potential optical obstructions to the optical measurement station based on the information of the site layout;
determine, for each station placement location of the plurality of potential station placement locations, the marking targets from the marking target list visible from the station placement location and the total number of visible marking targets; and
add a station location with a greatest number of visible marking targets to a station placement list.

13. The system of claim 12, comprising a ground printer and a ground printer controller, and wherein the ground printer controller is to:
cause the ground printer to receive ground printer location information from a first optical measurement station during a first time period and to receive ground printer location information from a second optical measurement station during a second time period.

14. The system of claim 11, wherein the ground printer controller is to:
cause the ground printer to receive ground printer location information from a first optical measurement station while the ground printer is printing at a first location and to receive ground printer location information from a second optical measurement station while the ground printer is printing at a second location.

15. A non-transitory machine-readable storage medium encoded with instructions which, when executed by a processor, cause the processor to:
retrieve site layout information;
define a marking target list comprising a plurality of marking targets and their location information based on the site layout plan;
define a plurality of station placement locations on the site for the optical measurement station based on the site layout plan;
define potential optical obstructions to the optical measurement station based on the site layout plan;
determine, for each station placement location of the plurality of station placement locations, the marking targets from the marking target list visible from the placement location and the total number of marking targets that are visible from the station placement location; and
add a station placement location with a greatest number of visible marking targets to a station placement list.
